(19) United States
(12) Patent Application Publication
(10) Pub. No.: US 2024/0097133 A1
(43) Pub. Date: Mar. 21, 2024

(54) BATTERY

(71) Applicant: Panasonic Intellectual Property Management Co., Ltd., Osaka (JP)

(72) Inventors: Yumi MIYAMOTO, Osaka (JP); Masahisa FUJIMOTO, Osaka (JP); Takashi OTO, Osaka (JP); Yoshimasa NAKAMA, Osaka (JP)

(21) Appl. No.: 18/526,790

(22) Filed: Dec. 1, 2023

Related U.S. Application Data
(63) Continuation of application No. PCT/JP2022/018781, filed on Apr. 25, 2022.

(30) Foreign Application Priority Data
Jun. 3, 2021 (JP) 2021-093944

(51) Int. Cl. H01M 4/62; C01B 25/14; C01F 17/36; C01G 23/00; C01G 53/00; H01M 4/36; H01M 4/38; H01M 4/505; H01M 4/525; H01M 10/0562; H01M 10/0585

(52) U.S. Cl. CPC H01M 4/62; C01B 25/14; C01F 17/36; C01G 23/002; C01G 53/52; H01M 4/366; H01M 4/38; H01M 4/505; H01M 4/525; H01M 10/0562; H01M 10/0585; H01M 2004/028

(57) ABSTRACT

A battery according to the present disclosure includes: a positive electrode; a negative electrode; and an electrolyte layer positioned between the positive electrode and the negative electrode. The positive electrode includes a positive electrode material. The positive electrode material includes a positive electrode active material and a first solid electrolyte material. The positive electrode active material includes an oxide consisting of Li, Ni, Mn, and O. The first solid electrolyte material includes: Li; at least one selected from the group consisting of metalloid elements and metal elements except Li; and at least one selected from the group consisting of F, Cl, and Br. The negative electrode includes Bi as a main component of a negative electrode active material.

This application is a continuation of PCT/JP2022/018781 filed on Apr. 25, 2022, which claims foreign priority of Japanese Patent Application No. 2021-093944 filed on Jun. 3, 2021, the entire contents of both of which are incorporated herein by reference.

### BACKGROUND OF THE INVENTION

### 1. Field of the Invention

The present disclosure relates to a battery.

### 2. Description of Related Art

JP 2006-244734 A discloses an all-solid-state secondary battery including a solid electrolyte formed of a compound containing indium as a cation and a halogen element as an anion. JP 2006-244734 A makes the following reference; in this all-solid-state secondary battery, a positive electrode active material has a potential of desirably 3.9 V or less on average versus Li, and this suppresses generation of a coating formed of a decomposition product resulting from oxidative decomposition of the solid electrolyte, thereby achieving favorable charge and discharge characteristics. JP 2006-244734 A also discloses a positive electrode in which a layered transition metal oxide such as LiCoO₂ or LiNi_{0.8}Co_{0.5}Al_{0.05}O₂ is used as a positive electrode active material having a potential of 3.9 V or less on average versus Li.

### SUMMARY OF THE INVENTION

The present disclosure provides a novel and operable battery in which a positive electrode active material including an oxide consisting of Li, Ni, Mn, and O is used.

A battery of the present disclosure includes:
a positive electrode;
a negative electrode; and
an electrolyte layer positioned between the positive electrode and the negative electrode, wherein
the positive electrode includes a positive electrode material,
the positive electrode material includes a positive electrode active material and a first solid electrolyte material,
the positive electrode active material includes an oxide consisting of Li, Ni, Mn, and O,
the first solid electrolyte material includes:
Li;
at least one selected from the group consisting of metalloid elements and metal elements except Li; and
at least one selected from the group consisting of F, Cl, and Br, and
the negative electrode includes Bi as a main component of a negative electrode active material.

The present disclosure provides a novel and operable battery in which a positive electrode active material including an oxide consisting of Li, Ni, Mn, and O is used.

### BRIEF DESCRIPTION OF THE DRAWINGS

FIG. 1 is a cross-sectional view schematically showing the configuration of a battery 2000 of Embodiment 1.

FIG. 2 is a cross-sectional view schematically showing the configuration of a battery 3000 of Embodiment 2.

FIG. 3 is a graph showing the charge and discharge curves of a battery of Example 1.

FIG. 4 is a graph showing the charge and discharge curves of a battery of Example 2.

### DETAILED DESCRIPTION

### (Outline of One Aspect According to the Present Disclosure)

A battery according to a first aspect of the present disclosure includes:
a positive electrode;
a negative electrode; and
an electrolyte layer positioned between the positive electrode and the negative electrode, wherein
the positive electrode includes a positive electrode material,
the positive electrode material includes a positive electrode active material and a first solid electrolyte material,
the positive electrode active material includes an oxide consisting of Li, Ni, Mn, and O,
the first solid electrolyte material includes:
Li;
at least one selected from the group consisting of metalloid elements and metal elements except Li; and
at least one selected from the group consisting of F, Cl, and Br, and
the negative electrode includes Bi as a main component of a negative electrode active material.

The first aspect provides a novel and operable battery in which a positive electrode active material including an oxide consisting of Li, Ni, Mn, and O is used. Furthermore, in the negative electrode of the battery according to the first aspect, Bi is included as the main component of the negative electrode active material. Bi does not have a property, as in tin, of a great variation in potential between compounds formed with lithium. Accordingly, electrodes including Bi as the active material are excellent in the flatness of the discharge voltage. Moreover, in the positive electrode of the battery according to the first aspect, the positive electrode active material includes the oxide consisting of Li, Ni, Mn, and O, and has a relatively high potential accordingly.

In a second aspect of the present disclosure, for example, in the battery according to the first aspect, the first solid electrolyte material may coat at least a portion of a surface of the positive electrode active material.

According to the second aspect, since at least a portion of the surface of the positive electrode active material is coated with the first solid electrolyte material, formation of an oxidative decomposition layer due to a halide solid electrolyte can be suppressed, thereby suppressing an increase in internal resistance. Consequently, the battery according to the second aspect has an enhanced charge and discharge capacity.

In a third aspect of the present disclosure, for example, in the battery according to the first or second aspect, the positive electrode material may further include a second electrolyte material that is a material having composition different from composition of the first solid electrolyte material.

The battery according to the third aspect has enhanced charge and discharge characteristics.

In a fourth aspect of the present disclosure, for example, in the battery according to any one of the first to third aspects, the positive electrode active material may include a material represented by the following composition formula (1)

LiNiₓMn₂₋ₓO₄ Formula (1), and
the composition formula (1) satisfies 0<x<2.

The battery according to the fourth aspect can operate at a high potential.

In a fifth aspect of the present disclosure, for example, in the battery according to the fourth aspect, the composition formula (1) may satisfy 0<x<1.

The battery according to the fifth aspect can operate at a higher potential.

In a sixth aspect of the present disclosure, for example, in the battery according to the fifth aspect, the composition formula (1) may satisfy x=0.5.

The battery according to the sixth aspect can operate at a higher potential.

In a seventh aspect of the present disclosure, for example, in the battery according to any one of the first to sixth aspects, the oxide may have a spinel structure.

The battery according to the seventh aspect can operate at a high potential.

In an eighth aspect of the present disclosure, for example, in the battery according to any one of the first to seventh aspects, the first solid electrolyte material may include Li, Ti, Al, and F.

The battery according to the eighth aspect includes the first solid electrolyte material having a high oxidation resistance. Consequently, it is possible to suppress a decrease in charge and discharge capacity due to oxidative decomposition of the first solid electrolyte material.

In a ninth aspect of the present disclosure, for example, in the battery according to any one of the first to eighth aspects, the negative electrode may include a simple substance of Bi as the negative electrode active material.

The battery according to the ninth aspect has enhanced charge and discharge characteristics.

In a tenth aspect of the present disclosure, for example, in the battery according to any one of the first to ninth aspects, the negative electrode may be a plating layer.

The battery according to the tenth aspect has an enhanced capacity.

In an eleventh aspect of the present disclosure, for example, in the battery according to the third aspect, the second electrolyte material may include a material represented by the following composition formula (3)

Li_{α3}M_{β3}X_{γ3}O_{δ3} Formula (3)
where α3, β3, and γ3 are each a value greater than 0, and δ3 is a value equal to or greater than 0, M is at least one selected from the group consisting of metalloid elements and metal elements except Li, and X is at least one selected from the group consisting of F, Cl, Br, and I.

The battery according to the eleventh aspect has enhanced charge and discharge characteristics.

In a twelfth aspect of the present disclosure, for example, in the battery according to the eleventh aspect, the composition formula (3) may satisfy:

1≤α3≤4;

0<β3≤2;

3≤γ3<7; and

0≤δ3<2.

In the battery according to the twelfth aspect, the ionic conductivity of the second electrolyte material can be enhanced. Consequently, resistance derived from migration of Li ions can be further reduced.

In a thirteenth aspect of the present disclosure, for example, in the battery according to the twelfth aspect, the composition formula (3) may satisfy:

2.5≤α3≤3;

1≤β3≤1.1;

γ3=6; and

δ3=0.

In the battery according to the thirteenth aspect, the ionic conductivity of the second electrolyte material can be enhanced. Consequently, resistance derived from migration of Li ions can be further reduced.

In a fourteenth aspect of the present disclosure, for example, in the battery according to any one of the first to thirteenth aspects, the electrolyte layer may include a sulfide solid electrolyte.

The battery according to the fourteenth aspect has further enhanced charge and discharge characteristics.

In a fifteenth aspect of the present disclosure, for example, in the battery according to the fourteenth aspect, the sulfide solid electrolyte may be Li₆PS₅Cl.

The battery according to the fifteenth aspect has further enhanced charge and discharge characteristics.

In a sixteenth aspect of the present disclosure, for example, in the battery according to any one of the first to fifteenth aspects, the electrolyte layer may include a material including: Li; at least one selected from the group consisting of metalloid elements and metal elements except Li; and at least one selected from the group consisting of F, Cl, and Br.

The battery according to sixteenth aspect has further enhanced charge and discharge characteristics.

In a seventeenth aspect of the present disclosure, for example, in the battery according to the sixteenth aspect, the electrolyte layer may include Li₃YBr₂Cl₄.

The battery according to the seventeenth aspect has further enhanced charge and discharge characteristics.

In an eighteenth aspect of the present disclosure, for example, in the battery according to any one of the first to seventeenth aspects, the electrolyte layer may include a first electrolyte layer and a second electrolyte layer, the first electrolyte layer is positioned between the positive electrode and the negative electrode, and the second electrolyte layer is positioned between the first electrolyte layer and the negative electrode.

In the battery according to the eighteenth aspect, an increase in internal resistance during charge can be suppressed.

In a nineteenth aspect of the present disclosure, for example, in the battery according to the eighteenth aspect, the positive electrode material may further include a second electrolyte material that is a material having composition different from composition of the first solid electrolyte material, and the first electrolyte layer includes a material having the same composition as composition of the second electrolyte material.

In the battery according to the nineteenth aspect, an increase in internal resistance during charge can be further suppressed.

Embodiments of the present disclosure will be described below with reference to the drawings. The following descriptions are each a generic or specific example. The following numerical values, composition, shape, film thickness, electrical characteristics, battery structure, and the like are only exemplary, and are not intended to limit the present disclosure.

### Embodiment 1

A battery of the present disclosure includes a positive electrode, a negative electrode, and an electrolyte layer positioned between the positive electrode and the negative electrode. The positive electrode includes a positive electrode material. The positive electrode material includes a positive electrode active material and a first solid electrolyte material. The positive electrode active material includes an oxide consisting of Li, Ni, Mn, and O. The first solid electrolyte material includes: Li; at least one selected from the group consisting of metalloid elements and metal elements except Li; and at least one selected from the group consisting of F, Cl, and Br. The negative electrode includes Bi as the main component of the negative electrode active material.

The phrase “the negative electrode includes Bi as the main component of the negative electrode active material” means that “the component having the highest content as the negative electrode active material on a molar ratio basis in the negative electrode is Bi”.

The first solid electrolyte material may coat at least a portion of the surface of the positive electrode active material.

The positive electrode material may further include a second electrolyte material that is a material having composition different from the composition of the first solid electrolyte material.

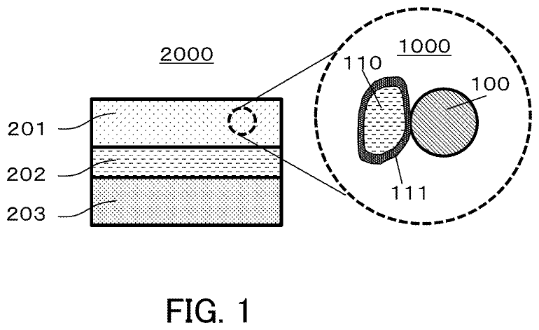

FIG. 1 is a cross-sectional view schematically showing the configuration of a battery 2000 of Embodiment 1.

The battery 2000 includes a positive electrode 201, a negative electrode 203, and an electrolyte layer 202 positioned between the positive electrode 201 and the negative electrode 203. The positive electrode 201 includes a positive electrode material 1000. The positive electrode material 1000 includes a positive electrode active material 110 and a first solid electrolyte material 111. The positive electrode active material 110 includes an oxide consisting of Li, Ni, Mn, and O. The first solid electrolyte material 111 includes: Li; at least one selected from the group consisting of metalloid elements and metal elements except Li; and at least one selected from the group consisting of F, Cl, and Br. The negative electrode 203 includes Bi as the main component of the negative electrode active material. In FIG. 1, a configuration example of the battery 2000 is shown in which the first solid electrolyte material 111 coats at least a portion of the surface of the positive electrode active material 110 and the positive electrode material 1000 further includes a second electrolyte material 100.

The constitutional elements of the battery 2000 of the present embodiment will be described below.

### [Positive Electrode 201]

As described above, the positive electrode 201 includes the positive electrode material 1000. The positive electrode material 1000 includes the positive electrode active material 110 and the first solid electrolyte material 111. The positive electrode active material 110 includes the oxide consisting of Li, Ni, Mn, and O. The first solid electrolyte material 111 includes: Li; at least one selected from the group consisting of metalloid elements and metal elements except Li; and at least one selected from the group consisting of F, Cl, and Br.

The “metalloid elements” refer to B, Si, Ge, As, Sb, and Te.

The “metal elements” refer to all the elements included in Groups 1 to 12 of the periodic table except hydrogen and all the elements included in Groups 13 to 16 except B, Si, Ge, As, Sb, Te, C, N, P, O, S, and Se. That is, the “metal elements” are a group of elements that can become a cation when forming an inorganic compound with a halogen compound.

With the above configuration, the positive electrode material 1000 has a high oxidation resistance. Consequently, the positive electrode material 1000 can suppress an increase in the internal resistance of the battery during charge. Moreover, the first solid electrolyte material 111 has a high ionic conductivity. Consequently, in the positive electrode material 1000, a low interfacial resistance between the first solid electrolyte material 111 and the positive electrode active material 110 can be achieved.

The first solid electrolyte material 111 may coat at least a portion of the surface of the positive electrode active material 110.

The positive electrode active material 110 may include a material represented by the following composition formula (1).

LiNiₓMn₂₋ₓO₄ Formula (1)

The composition formula (1) satisfies 0<x<2.

The composition formula (1) may satisfy 0<x<1.

The composition formula (1) may satisfy x=0.5. That is, the positive electrode active material 110 may include LiNi_{0.5}Mn_{1.5}O₄.

An oxide represented by these chemical formulae is a material obtained by substituting a portion of Mn in LiMn₂O₄ having a spinel structure with Ni, and is suitable for enhancing the operating voltage of a battery. The oxide consisting of Li, Ni, Mn, and O can have a spinel structure as well. The “oxide consisting of Li, Ni, Mn, and O” means that elements except Li, Ni, Mn, and O are not intentionally added, except for inevitable impurities.

With the above configuration, it is possible to suppress a decrease in the charge and discharge capacity of a battery. Moreover, a material represented by the composition formula (1) is free of Co, and is inexpensive accordingly. With the above configuration, the cost of the battery 2000 can be reduced.

The oxide consisting of Li, Ni, Mn, and O may have a spinel structure.

The positive electrode active material 110 may consist of LiNi_{0.5}Mn_{1.5}O₄.

With the above configuration, it is possible to suppress a decrease in the charge and discharge capacity of a battery.

The first solid electrolyte material 111 may include Li, Ti, Al, and F.

The first solid electrolyte material 111 may consist substantially of Li, Ti, Al, and F.

The phrase “the first solid electrolyte material 111 consists substantially of Li, Ti, Al, and F” means that the molar ratio of the sum of the amounts of substance of Li, Ti, Al, and F to the total of the amounts of substance of all the elements constituting the first solid electrolyte material 111 (i.e., the mole fraction) is 90% or more. In an example, the molar ratio may be 95% or more.

The first solid electrolyte material 111 may consist of Li, Ti, Al, and F.

The first solid electrolyte material 111 may include a material represented by the following composition formula (2A).

Li_{α1}Ti_{β1}Al_{γ1}F_{δ1} Formula (2A)

In the composition formula (2A), α1, β1, γ1, and δ1 are each a value greater than 0.

In the composition formula (2A), δ1 may be a value greater than α1, and δ1 may be a value greater than each of α1, β1, and γ1.

The composition formula (2A) may satisfy 1.7≤α1≤3.7, 0<β1<1.5, 0<γ1<1.5, and 5≤δ1≤7.

The composition formula (2A) may satisfy 2.5≤α|<3, 0.1≤β1≤0.6, 0.4≤γ1≤0.9, and δ1=6.

The first solid electrolyte material 111 may include a material represented by the composition formula (2A) as its main component. Here, the phrase “the first solid electrolyte material 111 includes a material represented by the composition formula (2A) as its main component” means that “the material having the highest content on a mass ratio basis in the first solid electrolyte material 111 is the material represented by the composition formula (2A)”.

The first solid electrolyte material 111 may include a material represented by the following composition formula (2B).

Li_{α2}Ti_{β2}Al_{γ2}F₆ Formula (2B)

In the composition formula (2B), α2, β2, and γ2 are each a value greater than 0.

The composition formula (2B) may satisfy α2+4β2+3γ2=6.

The composition formula (2B) may satisfy α2=2.7, β2=0.3, and γ2=0.7. That is, the first solid electrolyte material 111 may include Li_{2.7}Ti_{0.3}Al_{0.7}F₆.

The first solid electrolyte material 111 may include a material represented by the composition formula (2B) as its main component. Here, the phrase “the first solid electrolyte material 111 includes a material represented by the composition formula (2B) as its main component” means that “the material having the highest content on a mass ratio basis in the first solid electrolyte material 111 is the material represented by the composition formula (2B)”.

The first solid electrolyte material 111 may include Li_{2.7}Ti_{0.3}Al_{0.7}F₆ as its main component.

The first solid electrolyte material 111 may consist of Li_{2.7}Ti_{0.3}Al_{0.7}F₆.

With the above configuration, the first solid electrolyte material 111 exhibits a higher ionic conductivity. Consequently, in the positive electrode material 1000, a low interfacial resistance between the first solid electrolyte material 111 and the positive electrode active material 110 can be achieved, thereby enhancing the charge and discharge efficiency of the battery 2000.

To further enhance the ionic conductivity of the first solid electrolyte material 111, the first solid electrolyte material 111 may contain an element other than F as an anion. Examples of the element, which may be contained as an anion, include Cl, Br, I, O, S, and Se. Furthermore, the first solid electrolyte material 111 may be free of sulfur.

The positive electrode material 1000 may further include the second electrolyte material 100 that is a material having composition different from the composition of the first solid electrolyte material 111.

The second electrolyte material 100 may include a material represented by the following composition formula (3).

Li_{α3}M_{β3}X_{γ3}O_{δ3} Formula (3)

In the composition formula (3), α3, β, and γ3 are each a value greater than 0, and δ3 is a value equal to or greater than 0, M is at least one selected from the group consisting of metalloid elements and metal elements except Li, and X is at least one selected from the group consisting of F, Cl, Br, and I.

With the above configuration, the ionic conductivity of the second electrolyte material 100 can be further enhanced. Consequently, resistance derived from migration of Li ions in the positive electrode material 1000 can be further reduced.

In the composition formula (3), M may include at least one selected from the group consisting of Y and Ta. That is, the second electrolyte material 100 may include, as a metal element, at least one selected from the group consisting of Y and Ta.

With the above configuration, the ionic conductivity of the second electrolyte material 100 can be further enhanced. Consequently, resistance derived from migration of Li ions in the positive electrode material 1000 can be further reduced.

The composition formula (3) may satisfy 1≤α3≤4, 0<β3≤2, 3≤γ3<7, and 0≤δ3≤2.

With the above configuration, the ionic conductivity of the second electrolyte material 100 can be further enhanced. Consequently, resistance derived from migration of Li ions in the positive electrode material 1000 can be further reduced.

The composition formula (3) may satisfy 2.5≤α3≤3, 1≤β3≤1.1, γ3=6, and δ3=0.

The second electrolyte material 100 including Y may be, for example, a compound represented by a composition formula LiₐMe_{b}Y_{c}X₆. Here, a+m′b+3c=6 and c>0 are satisfied. Me is at least one element selected from the group consisting of metalloid elements and metal elements except Li and Y. Furthermore, m′ represents the valence of Me.

Me may be at least one element selected from the group consisting of Mg, Ca, Sr, Ba, Zn, Sc, Al, Ga, Bi, Zr, Hf, Ti, Sn, Ta, and Nb.

With the above configuration, the ionic conductivity of the second electrolyte material 100 can be further enhanced. Consequently, resistance derived from migration of Li ions in the positive electrode material 1000 can be further reduced.

The second electrolyte material 100 may be a material represented by the following composition formula (A1).

Li_{6-3d}Y_{d}X₆ Formula (A1)

In the composition formula (A1), X is a halogen element and includes Cl. Furthermore, the composition formula (A1) satisfies 0<d<2.

With the above configuration, the ionic conductivity of the second electrolyte material 100 can be further enhanced. Consequently, resistance derived from migration of Li ions in the positive electrode material 1000 can be further reduced.

The second electrolyte material 100 may be a material represented by the following composition formula (A2).

Li₃YX₆ Formula (A2)

In the composition formula (A2), X is a halogen element and includes Cl.

With the above configuration, the ionic conductivity of the second electrolyte material 100 can be further enhanced. Consequently, resistance derived from migration of Li ions in the positive electrode material 1000 can be further reduced.

The second electrolyte material 100 may be a material represented by the following composition formula (A3).

Li_{3-3δ}Y_{1+δ}Cl₆ Formula (A3)

The composition formula (A3) satisfies 0<6 5 0.15.

With the above configuration, the ionic conductivity of the second electrolyte material 100 can be further enhanced. Consequently, resistance derived from migration of Li ions in the positive electrode material 1000 can be further reduced.

The second electrolyte material 100 may be a material represented by the following composition formula (A4).

Li_{3-3δ+a4}Y_{1+δ-a4}Meₐ₄Cl₆₋ₓ₄Brₓ₄ Formula (A4)

In the composition formula (A4), Me is at least one element selected from the group consisting of Mg, Ca, Sr, Ba, and Zn. Furthermore, the composition formula (A4) satisfies −1<δ<2, 0<a4<3, 0<(3−3δ+a4), 0<(1+δ−a4), and 0≤x4<6.

With the above configuration, the ionic conductivity of the second electrolyte material 100 can be further enhanced. Consequently, resistance derived from migration of Li ions in the positive electrode material 1000 can be further reduced.

The second electrolyte material 100 may be a material represented by the following composition formula (A5).

Li_{3-3δ}Y_{1+δ-a5}Meₐ₅Cl₆₋ₓ₅Brₓ₅ Formula (A5)

In the composition formula (A5), Me is at least one element selected from the group consisting of Al, Sc, Ga, and Bi. Furthermore, the composition formula (A5) satisfies −1<δ<1, 0<a5<2, 0<(1+δ−a5), and 0≤−x5<6.

With the above configuration, the ionic conductivity of the second electrolyte material 100 can be further enhanced. Consequently, resistance derived from migration of Li ions in the positive electrode material 1000 can be further reduced.

The second electrolyte material 100 may be a material represented by the following composition formula (A6).

Li_{3-3δ-a6}Y_{1+δ-a6}Meₐ₆Cl₆₋ₓ₆Brₓ₆ Formula (A6)

In the composition formula (A6), Me is at least one element selected from the group consisting of Zr, Hf, and Ti. Furthermore, the composition formula (A6) satisfies −1<δ<1, 0<a6<1.5, 0<(3−3δ−a6), 0<(1+δ−a6), and 0≤x6<6.

The second electrolyte material 100 may be a material represented by the following composition formula (A7).

Li_{3-3δ-2a}Y_{1+δ-a7}Meₐ₇Cl₆₋ₓ₇Brₓ₇ Formula (A7)

In the composition formula (A7), Me is at least one element selected from the group consisting of Ta and Nb. Furthermore, the composition formula (A7) satisfies −1<δ<1, 0<a7<1.2, 0<(3−3δ−2a7), 0<(1+δ−a7), and 0≤x7<6.

The second electrolyte material 100 can be, for example, Li₃YX₆, Li₂MgX₄, Li₂FeX₄, Li(Al,Ga,In)X₄, or Li₃(Al,Ga,In)X₆. Here, X includes Cl. Note that, in the present disclosure, when an element in a formula is expressed by, for example, “(Al,Ga,In)”, this expression indicates at least one element selected from the group of elements in parentheses. That is, “(Al,Ga,In)” is synonymous with “at least one selected from the group consisting of Al, Ga, and In”. The same applies to other elements. In addition, the second electrolyte material 100 may be free of sulfur.

The second electrolyte material 100 may include a sulfide solid electrolyte. The sulfide solid electrolyte can be, for example, Li₂S—P₂S₅, Li₂S—SiS₂, Li₂S—B₂S₃, Li₂S—GeS₂, Li_{3.25}Ge_{0.25}P_{0.75}S₄, Li₁₀GeP₂S₁₂, or Li₆PS₅Cl. Furthermore, LiX, Li₂O, MO_{q}, LiₚMO_{q}, or the like may be added to these. Here, X is at least one element selected from the group consisting of F, Cl, Br, and I. M is at least one element selected from the group consisting of P, Si, Ge, B, Al, Ga, In, Fe, and Zn. The symbols p and q are each independently a natural number.

The second electrolyte material 100 may include lithium sulfide and phosphorus sulfide. The sulfide solid electrolyte may be at least one selected from the group consisting of Li₂S—P₂S₅ and Li₆PS₅Cl.

The second electrolyte material 100 may be a sulfide solid electrolyte.

The second electrolyte material 100 may further include an electrolyte solution.

The electrolyte solution includes an aqueous or nonaqueous solvent and a lithium salt dissolved in the solvent.

Examples of the solvent include water, a cyclic carbonate solvent, a linear carbonate solvent, a cyclic ether solvent, a linear ether solvent, a cyclic ester solvent, a linear ester solvent, and a fluorinated solvent.

Examples of the cyclic carbonate solvent include ethylene carbonate, propylene carbonate, and butylene carbonate. Examples of the linear carbonate solvent include dimethyl carbonate, ethyl methyl carbonate, and diethyl carbonate. Examples of the cyclic ether solvent include tetrahydrofuran, 1,4-dioxane, and 1,3-dioxolane. Examples of the linear ether solvent include 1,2-dimethoxyethane and 1,2-diethoxyethane. Examples of the cyclic ester solvent include γ-butyrolactone. Examples of the linear ester solvent include methyl acetate. Examples of the fluorinated solvent include fluoroethylene carbonate, methyl fluoropropionate, fluorobenzene, fluoroethyl methyl carbonate, and fluorodimethylene carbonate.

As the solvent, one solvent selected from these can be used alone, or alternatively, a combination of two or more solvents selected from these can be used.

The electrolyte solution may contain at least one fluorinated solvent selected from the group consisting of fluoroethylene carbonate, methyl fluoropropionate, fluorobenzene, fluoroethyl methyl carbonate, and fluorodimethylene carbonate.

The lithium salt can be LiPF₆, LiBF₄, LiSbF₆, LiAsF₆, LiSO₃CF₃, LiN(SO₂CF₃)₂, LiN(SO₂C₂F₅)₂, LiN(SO₂CF₃)(SO₂C₄F₉), LiC(SO₂CF₃)₃, or the like. As the lithium salt, one lithium salt selected from these can be used alone, or alternatively, a mixture of two or more lithium salts selected from these can be used. The concentration of the lithium salt is, for example, in a range of 0.1 mol/L to 15 mol/L.

The positive electrode material 1000 may further include a positive electrode active material that is other than the positive electrode active material 110 including the oxide consisting of Li, Ni, Mn, and O.

Positive electrode active materials include a material having properties of occluding and releasing metal ions (e.g., lithium ions). The positive electrode active material other than the positive electrode active material 110 can be, for example, a lithium-containing transition metal oxide, a transition metal fluoride, a polyanion material, a fluorinated polyanion material, a transition metal sulfide, a transition metal oxysulfide, or a transition metal oxynitride. Examples of the lithium-containing transition metal oxide include Li(Ni,Co,Al)O₂, Li(Ni,Co,Mn)O₂, and LiCoO₂. In particular, in the case where the lithium-containing transition metal oxide is used, it is possible to reduce the manufacturing cost of the positive electrode material 1000, and to enhance the average discharge voltage.

The first solid electrolyte material 111 may be provided between the positive electrode active material 110 and the second electrolyte material 100.

With the above configuration, owing to the interposition of the first solid electrolyte material 111 having a high oxidation resistance between the positive electrode active material 110 and the second electrolyte material 100, oxidative decomposition of the second electrolyte material 100 can be suppressed. Consequently, it is possible to suppress a decrease in the capacity of the battery 2000 during charge.

In the case where the first solid electrolyte material 111 coats at least a portion of the surface of the positive electrode active material 110, the first solid electrolyte material 111, which coats the at least portion of the surface of the positive electrode active material 110, may have a thickness of 1 nm or more and 500 nm or less.

In the case where the first solid electrolyte material 111 has a thickness of 1 nm or more, a direct contact between the positive electrode active material 110 and the second electrolyte material 100 can be suppressed, thereby suppressing oxidative decomposition of the second electrolyte material 100. Consequently, it is possible to enhance the charge and discharge efficiency of the battery including the positive electrode material 1000. In the case where the first solid electrolyte material 111 has a thickness of 500 nm or less, the first solid electrolyte material 111 is not excessively large in thickness. Consequently, it is possible to sufficiently reduce the internal resistance of the battery including the positive electrode material 1000, thereby enhancing the energy density of the battery.

The method of measuring the thickness of the first solid electrolyte material 111 is not particularly limited. For example, a transmission electron microscope can be used to directly observe the first solid electrolyte material 111 and thus to determine the thickness.

The mass proportion of the first solid electrolyte material 111 to the positive electrode active material 110 may be 0.01% or more and 30% or less.

In the case where the mass proportion of the first solid electrolyte material 111 to the positive electrode active material 110 is 0.01% or more, a direct contact between the positive electrode active material 110 and the second electrolyte material 100 can be suppressed, thereby suppressing oxidative decomposition of the second electrolyte material 100. Consequently, it is possible to enhance the charge and discharge efficiency of the battery. In the case where the mass proportion of the first solid electrolyte material 111 to the positive electrode active material 110 is 30% or less, the thickness of the first solid electrolyte material 111 is not excessively large. Consequently, it is possible to sufficiently reduce the internal resistance of the battery, thereby enhancing the energy density of the battery.

The first solid electrolyte material 111 may uniformly coat the surface of the positive electrode active material 110. In this case, a direct contact between the positive electrode active material 110 and the second electrolyte material 100 can be suppressed, thereby suppressing a side reaction of the second electrolyte material 100. Consequently, it is possible to further enhance the charge and discharge characteristics of the battery and to suppress a decrease in the capacity of the battery.

The first solid electrolyte material 111 may coat a portion of the surface of the positive electrode active material 110. In this case, the plurality of positive electrode active materials 110 are in direct contact with each other via their portions uncoated with the first solid electrolyte material 111. Consequently, the electronic conductivity between the plurality of positive electrode active materials 110 is enhanced. This enables the battery to operate at a high power.

The first solid electrolyte material 111 may coat 30% or more, 60% or more, or 90% or more of the surface of the positive electrode active material 110. The first solid electrolyte material 111 may coat substantially the entire surface of the positive electrode active material 110.

At least a portion of the surface of the positive electrode active material 110 may be coated with a coating material that is different from the first solid electrolyte material 111.

Examples of the coating material include a sulfide solid electrolyte, an oxide solid electrolyte, and a fluoride solid electrolyte. The sulfide solid electrolyte used as the coating material may be the same material as any of the materials exemplified for the second electrolyte material 100. Examples of the oxide solid electrolyte used as the coating material include a Li—Nb—O compound, such as LiNbO₃, a Li—B—O compound, such as LiBO₂ or Li₃BO₃, a Li—Al—O compound, such as LiAlO₂, a Li—Si—O compound, such as Li₄SiO₄, a Li—Ti—O compound, such as Li₂SO₄ or Li₄Ti₅O₁₂, a Li—Zr—O compound, such as Li₂ZrO₃, a Li—Mo—O compound, such as Li₂MoO₃, a Li-V-O compound, such as LiV₂O₅, a Li—W—O compound, such as Li₂WO₄, and a Li—P—O compound, such as Li₃PO₄. An example of the fluoride solid electrolyte used as the coating material is a solid electrolyte including Li, Ti, M1, and F, where M1 is at least one element selected from the group consisting of Ca, Mg, Al, Y, and Zr.

With the above configuration, the oxidation resistance of the positive electrode material 1000 can be further enhanced. Consequently, a decrease in the capacity of the battery 2000 during charge can be suppressed.

The positive electrode active material 110 and the first solid electrolyte material 111 may be separated from each other by the coating material so as not to be in direct contact with each other.

With the above configuration, the oxidation resistance of the positive electrode material 1000 can be further enhanced. Consequently, a decrease in the capacity of the battery during charge can be suppressed.

The shape of the second electrolyte material 100 is not particularly limited. In the case where the second electrolyte material 100 is a powdery material, its shape may be, for example, an acicular, spherical, or ellipsoidal shape. The second electrolyte material 100 may be, for example, particulate.

For example, in the case where the second electrolyte material 100 is particulate (e.g., spherical), the second electrolyte material 100 may have a median diameter of 100 μm or less. In the case where the second electrolyte material 100 has a median diameter of 100 μm or less, the positive electrode active material 110 and the second electrolyte material 100 can form a favorable dispersion state in the positive electrode material 1000. This enhances the charge and discharge characteristics of the battery including the positive electrode material 1000.

The second electrolyte material 100 may have a median diameter of 10 μm or less. With the above configuration, the positive electrode active material 110 and the second electrolyte material 100 can form a favorable dispersion state in the positive electrode material 1000.

In Embodiment 1, the second electrolyte material 100 may have a smaller median diameter than the positive electrode active material 110 has. With the above configuration, the second electrolyte material 100 and the positive electrode active material 110 can form a more favorable dispersion state in the positive electrode.

The positive electrode active material 110 may have a median diameter of 0.1 μm or more and 100 μm or less.

In the case where the positive electrode active material 110 has a median diameter of 0.1 μm or more, the positive electrode active material 110 and the second electrolyte material 100 can form a favorable dispersion state in the positive electrode material 1000. This enhances the charge and discharge characteristics of the battery including the positive electrode material 1000. In the case where the positive electrode active material 110 has a median diameter of 100 μm or less, the diffusion rate of lithium in the positive electrode active material 110 is enhanced. Consequently, the battery including the positive electrode material 1000 can operate at a high power.

The positive electrode active material 110 may have a larger median diameter than the second electrolyte material 100 has. In this case, the positive electrode active material 110 and the second electrolyte material 100 can form a favorable dispersion state.

In the present disclosure, the “median diameter” means the particle diameter at a cumulative volume equal to 50% in the volumetric particle size distribution. The volumetric particle size distribution is measured, for example, with a laser diffraction analyzer or an image analyzer.

In the positive electrode material 1000, the second electrolyte material 100 and the first solid electrolyte material 111 may be in contact with each other as shown in FIG. 1. In this case, the first solid electrolyte material 111 and the positive electrode active material 110 are in contact with each other.

The positive electrode material 1000 may include the plurality of second electrolyte materials 100 and the plurality of positive electrode active materials 110.

In the positive electrode material 1000, the content of the second electrolyte material 100 and the content of the positive electrode active material 110 may be the same or different from each other.

In the volume ratio “v1:100-v1” of the sum of the positive electrode active material 110 and the first solid electrolyte material 111 to the second electrolyte material 100, all of which are included in the positive electrode 201, 30≤v1≤98 may be satisfied. Here, v1 represents the volume ratio of the sum of the positive electrode active material 110 and the first solid electrolyte material 111 based on 100 of the total volume of the positive electrode active material 110, and the first solid electrolyte material 111, and the second electrolyte material 100 included in the positive electrode 201. In the case where 30≤v1 is satisfied, a sufficient energy density of the battery can be ensured. In the case where v1≤98 is satisfied, the battery 2000 can operate at a high power.

The positive electrode 201 may have a thickness of 10 μm or more and 500 μm or less. In the case where the positive electrode 201 has a thickness of 10 μm or more, a sufficient energy density of the battery can be ensured. In the case where the positive electrode 201 has a thickness of 500 μm or less, the battery 2000 can operate at a high power.

### <Method of Manufacturing Positive Electrode Material 1000>

The positive electrode material 1000 included in the battery 2000 of Embodiment 1 can be manufactured, for example, by the following method.

First, the first solid electrolyte material 111 is produced. Raw material powders of a binary halide are prepared so as to obtain a blending ratio of a desired composition. For example, to produce Li_{2.7}Ti_{0.3}Al_{0.7}F₆, LiF, TiF₄, and AlF₃ are prepared in an approximate molar ratio of LiF:TiF₄:AlF₃=2.7:0.3:0.7. The blending ratio may be adjusted in advance so as to cancel out a composition change that can occur in the synthesis process.

The raw material powders are well mixed together, and then mixed, pulverized, and reacted together by mechanochemical milling. Subsequently, the raw material powders may be fired in a vacuum or in an inert atmosphere. Alternatively, the raw material powders may be well mixed together, and then fired in a vacuum or in an inert atmosphere. The firing is performed preferably under firing conditions of, for example, a range of 100° C. to 300° C. and 1 hour or more. Furthermore, to suppress a composition change in the firing process, the firing is performed preferably by sealing the raw material powders in a closed vessel, such as a quartz tube.

Thus, the first solid electrolyte material 111 having such composition as the composition described above is obtained.

Next, the positive electrode active material 110 and the first solid electrolyte material 111 are prepared in a predetermined mass ratio. For example, LiNi_{0.5}Mn_{1.5}O₄ is prepared as the positive electrode active material 110 and Li_{2.7}Ti_{0.3}Al_{0.7}F₆ is prepared as the first solid electrolyte material 111. These two materials are put into the same reaction vessel. A shear force is imparted to the two materials with rotating blades, or a jet stream is used to collide the two materials with each other, for example. By such a method, at least a portion of the surface of LiNi_{0.5}Mn_{1.5}O₄, which is the positive electrode active material 110, can be coated with Li_{2.7}Ti_{0.3}Al_{0.7}F₆, which is the first solid electrolyte material 111. Examples of usable devices include a dry particle composing machine NOBILTA (manufactured by Hosokawa Micron Corporation), a high-speed flow impact machine (manufactured by Nara Machinery Co., Ltd.), and a jet mill. Thus, it is possible to manufacture a positive electrode active material in which at least a portion of the surface of LiNi_{0.5}Mn_{1.5}O₄, which is the positive electrode active material 110, is coated with Li_{2.7}Ti_{0.3}Al_{0.7}F₆, which is the first solid electrolyte material 111.

Next, the second electrolyte material 100 is produced. In an example, to synthesize the second electrolyte material 100 consisting of Li, Y, Cl, and Br, raw material powders LiCl, LiBr, YBr₃, and YCl₃ are mixed together. The molar ratio in mixing the raw material powders together may be adjusted in advance so as to cancel out a composition change that can occur in the synthesis process. Thus, the second electrolyte material 100 is obtained.

The positive electrode active material 110 having a surface coated with the first solid electrolyte material 111 and the second electrolyte material 100 are mixed together. Thus, the positive electrode material 1000 can be manufactured.

### [Negative Electrode 203]

The negative electrode 203 includes a material having properties of occluding and releasing metal ions (e.g., lithium ions). That is, the negative electrode 203 includes the negative electrode active material. The negative electrode 203 includes Bi as the main component of the negative electrode active material.

Bi is an active material that occludes and releases lithium ions at 0.8 V vs. lithium. Bi is a metal that alloys with lithium. During charge, lithium is occluded into Bi and thus Bi forms an alloy with lithium. That is, during charge of the battery 2000, a lithium-bismuth alloy is generated in the negative electrode 203. The lithium-bismuth alloy generated includes, for example, at least one selected from the group consisting of LiBi and Li₃Bi. That is, during charge of the battery 2000, the negative electrode 203 includes, for example, at least one selected from the group consisting of LiBi and Li₃Bi. During discharge of the battery 2000, lithium is released from the lithium-bismuth alloy and thus the lithium-bismuth alloy returns to Bi.

Bi does not have a property, as in tin and the like, of a great variation in potential between compounds formed with lithium. Accordingly, the negative electrode 203 including Bi as the negative electrode active material is excellent in the flatness of the discharge voltage.

The negative electrode 203 may include at least one selected from the group consisting of LiBi and Li₃Bi.

The negative electrode 203 may include a simple substance of Bi as the negative electrode active material.

The negative electrode 203 may include only a simple substance of Bi as the negative electrode active material.

The negative electrode 203 may include, as the negative electrode active material, a material other than Bi.

The negative electrode active material can be a metal material, a carbon material, an oxide, a nitride, a tin compound, a silicon compound, or the like. The metal material may be a simple substance of metal. Alternatively, the metal material may be an alloy. Examples of the metal material include lithium metal and a lithium alloy. Examples of the carbon material include natural graphite, coke, semi-graphitized carbon, a carbon fiber, spherical carbon, artificial graphite, and amorphous carbon. From the viewpoint of capacity density, silicon, tin, a silicon compound, or a tin compound can be used.

The negative electrode 203 may be free of an electrolyte. The negative electrode 203 may be, for example, a layer formed of at least one selected from the group consisting of a simple substance of Bi and a lithium-bismuth alloy that is generated during charge.

The negative electrode 203 may be filmy.

The negative electrode 203 may be a plating layer.

The negative electrode 203 may be a plating layer formed by depositing Bi by plating.

The thickness of the negative electrode 203 is not particularly limited, and may be, for example, 1 μm or more and 500 μm or less. For example, in the case where the negative electrode 203 is a plating layer formed by depositing Bi by plating, the negative electrode 203 may have a thickness of, for example, 1 μm or more and 100 μm or less. In the case where the negative electrode 203 has a thickness of 1 μm or more, a sufficient energy density of the battery 2000 can be ensured. In the case where the negative electrode 203 has a thickness of 500 μm or less, the battery 2000 can operate at a high power.

The negative electrode 203 may further include a conductive material. Examples of the conductive material include a carbon material, a metal, an inorganic compound, and a conductive polymer. Examples of the carbon material include graphite, acetylene black, carbon black, Ketjenblack, a carbon whisker, needle coke, and a carbon fiber. Examples of the graphite include natural graphite and artificial graphite. Examples of the natural graphite include vein graphite and flake graphite. Examples of the metal include copper, nickel, aluminum, silver, and gold. Examples of the inorganic compound include tungsten carbide, titanium carbide, tantalum carbide, molybdenum carbide, titanium boride, and titanium nitride. These materials may be used alone or in mixture.

In the battery 2000 of Embodiment 1, a current collector electrically connected to the positive electrode 201 and a current collector electrically connected to the negative electrode 203 may be provided. That is, the battery 2000 may further include a positive electrode current collector and a negative electrode current collector.

The negative electrode 203 may be disposed in direct contact with the surface of the negative electrode current collector.

The negative electrode 203 may be a plating layer formed by depositing Bi on the negative electrode current collector by plating. The negative electrode 203 may be a plating layer formed of Bi provided in direct contact with the surface of the negative electrode current collector.

In the case where the negative electrode 203 is a plating layer provided in direct contact with the surface of the negative electrode current collector, the negative electrode 203 is in close contact with the negative electrode current collector. Consequently, it is possible to suppress a deterioration in the current collection characteristics of the negative electrode 203 caused by repetition of expansion and contraction of the negative electrode 203. This further enhances the charge and discharge characteristics of the battery 2000. Furthermore, in the case where the negative electrode 203 is a Bi-plating layer, the negative electrode 203 includes a high density of Bi, which is an active material. Consequently, a further increase in capacity can also be achieved.

The material for the negative electrode current collector is, for example, a simple substance of metal or an alloy. More specifically, the material may be a simple substance of metal including, or an alloy including, at least one selected from the group consisting of copper, chromium, nickel, titanium, platinum, gold, aluminum, tungsten, iron, and molybdenum. The material for the negative electrode current collector may be stainless steel. In addition, these materials can also be used as the material for the positive electrode current collector.

The negative electrode current collector may include copper (Cu).

To easily ensure a high conductivity, the negative electrode current collector may be a metal foil, and may be a metal foil including copper. Examples of the metal foil including copper include a copper foil and a copper alloy foil. The content of copper in the metal foil including copper may be 50 mass % or more or 80 mass % or more. In particular, the metal foil including copper may be a copper foil including substantially only copper as a metal.

### [Electrolyte Layer 202]

The electrolyte layer 202 is disposed between the positive electrode 201 and the negative electrode 203.

The electrolyte layer 202 includes an electrolyte material. The electrolyte material is, for example, a solid electrolyte material. The electrolyte layer 202 may be a solid electrolyte layer.

The solid electrolyte material included in the electrolyte layer 202 may be a material that is the same as the first solid electrolyte material 111 or the same as the second electrolyte material 100. That is, the electrolyte layer 202 may include a material having the same composition as the composition of the first solid electrolyte material 111 or having the same composition as the composition of the second electrolyte material 100. The electrolyte layer 202 may include a material including: Li; at least one selected from the group consisting of metalloid elements and metal elements except Li; and at least one selected from the group consisting of F, Cl, and Br. The electrolyte layer 202 may include a material represented by the above composition formula (3).

With the above configuration, the output density and the charge and discharge characteristics of the battery 2000 can be further enhanced.

The solid electrolyte material included in the electrolyte layer 202 may be the same material as the first solid electrolyte material 111. That is, the electrolyte layer 202 may include a material having the same composition as the composition of the first solid electrolyte material 111.

With the above configuration, an increase in the internal resistance of the battery 2000 caused by oxidation of the electrolyte layer 202 can be suppressed, thereby further enhancing the output density and the charge and discharge characteristics of the battery 2000.

The solid electrolyte material included in the electrolyte layer 202 may be a halide solid electrolyte, a sulfide solid electrolyte, an oxide solid electrolyte, a polymer solid electrolyte, or a complex hydride solid electrolyte.

The oxide solid electrolyte, which may be included in the electrolyte layer 202, can be, for example: a NASICON solid electrolyte typified by LiTi₂(PO₄)₃ and element-substituted substances thereof; a (LaLi)TiO₃-based perovskite solid electrolyte; a LISICON solid electrolyte typified by Li₁₄ZnGe₄O₁₆, Li₄SiO₄, and LiGeO₄ and element-substituted substances thereof; a garnet solid electrolyte typified by Li₇La₃Zr₂O₁₂ and element-substituted substances thereof; Li₃PO₄ and N-substituted substances thereof; or glass or glass ceramics including a Li—B—O compound, such as LiBO₂ or Li₃BO₃, as a base, and to which Li₂SO₄, Li₂CO₃, or the like is added.

The polymer solid electrolyte, which may be included in the electrolyte layer 202, can be, for example, a compound of a polymer compound and a lithium salt. The polymer compound may have an ethylene oxide structure. The polymer compound having an ethylene oxide structure can include a large amount of a lithium salt. Consequently, the ionic conductivity can be further enhanced. The lithium salt can be LiPF₆, LiBF₄, LiSbF₆, LiAsF₆, LiSO₃CF₃, LiN(SO₂CF₃)₂, LiN(SO₂C₂F₅)₂, LiN(SO₂CF₃)(SO₂C₄F₉), LiC(SO₂CF₃)₃, or the like. One lithium salt selected from the exemplified lithium salts can be used alone. Alternatively, a mixture of two or more lithium salts selected from the exemplified lithium salts can be used.

The complex hydride solid electrolyte, which may be included in the electrolyte layer 202, can be, for example, LiBH₄—LiI or LiBH₄—P₂S₅.

The electrolyte layer 202 may include the solid electrolyte material as its main component. That is, the electrolyte layer 202 may include the solid electrolyte material, for example, in a mass proportion of 50% or more (i.e., 50 mass % or more) to the entire electrolyte layer 202.

With the above configuration, the charge and discharge characteristics of the battery 2000 can be further enhanced.

The electrolyte layer 202 may include the solid electrolyte material, for example, in a mass proportion of 70% or more (i.e., 70 mass % or more) to the entire electrolyte layer 202.

With the above configuration, the charge and discharge characteristics of the battery 2000 can be further enhanced.

The electrolyte layer 202 may include the solid electrolyte material as its main component and further include inevitable impurities, a starting material used for synthesis of the solid electrolyte material, a by-product, a decomposition product, etc.

The electrolyte layer 202 may include the solid electrolyte material, for example, in a mass proportion of 100% (i.e., 100 mass %) to the entire electrolyte layer 202, except for inevitably incorporated impurities.

With the above configuration, the charge and discharge characteristics of the battery 2000 can be further enhanced.

Thus, the electrolyte layer 202 may consist of the solid electrolyte material.

The electrolyte layer 202 may include two or more of the materials listed as the solid electrolyte material. For example, the electrolyte layer 202 may include a halide solid electrolyte and a sulfide solid electrolyte.

The electrolyte layer 202 may include Li₆PS₅Cl.

The electrolyte layer 202 may include Li₃YBr₂Cl₄.

The electrolyte layer 202 may have a thickness of 1 μm or more and 300 μm or less. In the case where the electrolyte layer 202 has a thickness of 1 μm or more, a short circuit between the positive electrode 201 and the negative electrode 203 tends not to occur. In the case where the electrolyte layer 202 has a thickness of 300 μm or less, the battery 2000 can operate at a high power.

The description has been provided here mainly on the case where the electrolyte layer 202 is a solid electrolyte layer including a solid electrolyte material. Alternatively, the electrolyte material included in the electrolyte layer 202 may be an electrolyte solution. For example, the electrolyte layer 202 may be composed of a separator and an electrolyte solution with which the separator is impregnated.

At least one selected from the group consisting of the positive electrode 201, the electrolyte layer 202 and the negative electrode 203 may include a binder for the purpose of enhancing the adhesion between the particles. The binder is used to enhance the binding properties of the materials for the electrodes. Examples of the binder include polyvinylidene fluoride, polytetrafluoroethylene, polyethylene, polypropylene, aramid resin, polyamide, polyimide, polyamide-imide, polyacrylonitrile, polyacrylic acid, polyacrylic acid methyl ester, polyacrylic acid ethyl ester, polyacrylic acid hexyl ester, polymethacrylic acid, polymethacrylic acid methyl ester, polymethacrylic acid ethyl ester, polymethacrylic acid hexyl ester, polyvinyl acetate, polyvinylpyrrolidone, polyether, polyethersulfone, hexafluoropolypropylene, styrene-butadiene rubber, and carboxymethylcellulose. Furthermore, the binder can be a copolymer of two or more materials selected from the group consisting of tetrafluoroethylene, hexafluoroethylene, hexafluoropropylene, perfluoroalkyl vinyl ether, vinylidene fluoride, chlorotrifluoroethylene, ethylene, propylene, pentafluoropropylene, fluoromethyl vinyl ether, acrylic acid, and hexadiene. Moreover, a mixture of two or more selected from these may be used.

At least one selected from the group consisting of the positive electrode 201 and the negative electrode 203 may include a conductive additive for the purpose of enhancing the electronic conductivity. The conductive additive can be, for example: graphite, such as natural graphite or artificial graphite; carbon black, such as acetylene black or Ketjenblack; a conductive fiber, such as a carbon fiber or a metal fiber; carbon fluoride; a metal powder, such as an aluminum powder; a conductive whisker, such as a zinc oxide whisker or a potassium titanate whisker; a conductive metal oxide, such as titanium oxide; or a conductive polymer compound, such as polyaniline compound, polypyrrole compound, or polythiophene compound. In the case where a conductive carbon additive is used as the conductive additive, cost reduction can be achieved.

The shape of the battery 2000 of Embodiment 1 is, for example, a coin type, a cylindrical type, a prismatic type, a sheet type, a button type, a flat type, or a stack type.

The battery 2000 of Embodiment 1 may be manufactured, for example, by preparing each of a material for forming a positive electrode, a material for forming an electrolyte layer, and a material for forming a negative electrode, and producing by a known method a stack in which the positive electrode, the electrolyte layer, and the negative electrode are disposed in this order.

### Embodiment 2

Embodiment 2 will be described below. The description overlapping with that of Embodiment 1 will be omitted as appropriate.

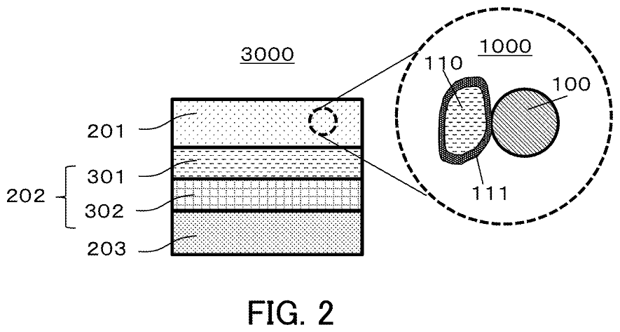

FIG. 2 is a cross-sectional view schematically showing the configuration of a battery 3000 of Embodiment 2.

The battery 3000 of Embodiment 2 includes the positive electrode 201, the electrolyte layer 202, and the negative electrode 203. The electrolyte layer 202 is disposed between the positive electrode 201 and the negative electrode 203. The electrolyte layer 202 includes a first electrolyte layer 301 and a second electrolyte layer 302. The first electrolyte layer 301 is positioned between the positive electrode 201 and the negative electrode 203, and the second electrolyte layer 302 is positioned between the first electrolyte layer 301 and the negative electrode 203. In FIG. 2, a configuration example of the battery 3000 is shown in which the first electrolyte layer 301 is in contact with the positive electrode 201 and the second electrolyte layer 302 is in contact with the negative electrode 203.

With the above configuration, an increase in the internal resistance of the battery 3000 during charge can be suppressed.

The first electrolyte layer 301 may include a material having the same composition as the composition of the second electrolyte material 100.

The first electrolyte layer 301 may include a material having the same composition as the composition of the first solid electrolyte material 111.

In the case where the first electrolyte layer 301 includes the material having the same composition as the composition of the first solid electrolyte material 111 having an excellent oxidation resistance, oxidative decomposition of the first electrolyte layer 301 can be suppressed, thereby suppressing an increase in the internal resistance of the battery 3000 during charge.

In addition, the second electrolyte layer 302 may include a material having composition different from the composition of the first solid electrolyte material 111.

For example, the reduction potential of the solid electrolyte material included in the second electrolyte layer 302 may be lower than the reduction potential of the solid electrolyte material included in the first electrolyte layer 301. With the above configuration, the solid electrolyte material included in the first electrolyte layer 301 tends not to be reduced. Consequently, the charge and discharge efficiency of the battery 3000 can be enhanced.

For example, the second electrolyte layer 302 may include a sulfide solid electrolyte. In this case, the reduction potential of the sulfide solid electrolyte included in the second electrolyte layer 302 may be lower than the reduction potential of the solid electrolyte material included in the first electrolyte layer 301. With the above configuration, the solid electrolyte material included in the first electrolyte layer 301 tends not to be reduced. Consequently, the charge and discharge efficiency of the battery 3000 can be enhanced.

The first electrolyte layer 301 and the second electrolyte layer 302 each may have a thickness of 1 μm or more and 300 μm or less. In the case where the first electrolyte layer 301 and the second electrolyte layer 302 each have a thickness of 1 μm or more, a short circuit between the positive electrode 201 and the negative electrode 203 tends not to occur. In the case where the first electrolyte layer 301 and the second electrolyte layer 302 each have a thickness of 300 μm or less, the battery 3000 can operate at a high power.

### EXAMPLES

The present disclosure will be described below in more detail with reference to examples.

### Example 1

### [Production of First Solid Electrolyte Material]

In an argon atmosphere, raw material powders LiF, TiF₄, and AlF₃ were weighed in a molar ratio of LiF:TiF₄:AlF₃=2.7:0.3:0.7. Subsequently, these raw material powders were milled with a planetary ball mill (Type P-7 manufactured by Fritsch GmbH) at 500 rpm for 12 hours thus to obtain powdered Li_{2.7}Ti_{0.3}Al_{0.7}F₆ as a first solid electrolyte material of Example 1.

[Production of Positive Electrode Active Material Having Surface Coated with First Solid Electrolyte Material]

In an argon atmosphere, the positive electrode active material LiNi_{0.5}Mn_{1.5}O₄ and the first solid electrolyte material of Example 1 were weighed in a mass ratio of LiNi_{0.5}Mn_{1.5}O₄:the first solid electrolyte material=100:3. These materials were put into a dry particle composing machine NOBILTA (manufactured by Hosokawa Micron Corporation) and subjected to a composing process at 6000 rpm for 30 minutes. Thus, a positive electrode active material having a surface coated with the first solid electrolyte material of Example 1 was obtained.

### [Production of Second Electrolyte Material]

In a dry atmosphere with a dew point of −30° C. or lower (hereinafter referred to as a “dry atmosphere”), raw material powders Li₂O₂ and TaCl₅ were prepared in a molar ratio of Li₂O₂:TaCl₅=1.2:2. These raw material powders were pulverized and mixed together in a mortar to obtain a mixed powder. The obtained mixed powder was milled with a planetary ball mill at 600 rpm for 24 hours. Next, the mixed powder was fired at 200° C. for 6 hours. Thus, a powdered Li—Ta—O—Cl-based second electrolyte material was obtained.

### [Production of Positive Electrode Material]

The positive electrode active material having a surface coated with the first solid electrolyte material of Example 1, the second electrolyte material of Example 1, and vapor-grown carbon fibers (VGCF (manufactured by SHOWA DENKO K.K.)) as the conductive additive were weighed in a mass ratio of the coated positive electrode active material:the second electrolyte material:VGCF=72.8:26.2:1.0, and were mixed together in a mortar. Thus, a positive electrode material of Example 1 was produced. Note that VGCF is the registered trademark of SHOWA DENKO K.K.

### [Production of Solid Electrolyte Material for Electrolyte Layer]

In an argon atmosphere, raw material powders LiBr, YBr₃, LiCl, and YCl₃ were weighed in a molar ratio of LiBr:YBr₃:LiCl:YCl₃=1:1:5:1. Subsequently, these raw material powders were milled with a planetary ball mill (Type P-7 manufactured by Fritsch GmbH) at 600 rpm for 25 hours thus to obtain powdered Li₃YBr₂Cl₄.

### [Production of Negative Electrode]

A pretreatment was performed in which a copper foil (10 cm×10 cm, thickness: 10 μm) was preliminarily degreased with an organic solvent, and then degreased by being immersed in an acidic solvent with its one side masked. Thus, the surface of the copper foil was activated. To 1.0 mol/L of methanesulfonic acid, methanesulfonic acid bismuth as a soluble bismuth salt was added so that Bi³⁺ ions reached 0.18 mol/L. Thus, a plating bath was produced. The copper foil activated was connected to a power source for current application, and then immersed in the plating bath. Subsequently, the unmasked surface of the copper foil was electroplated with Bi by controlling the current density to 2 A/dm² so that the thickness reached about 3 μm. The copper foil subjected to the electroplating was taken out from the acidic bath, and the mask was removed. Then, the copper foil was cleaned with pure water and dried. Subsequently, the copper foil was punched to have a size of φ0.92 cm. Thus, a negative electrode was obtained that was a plating layer formed by depositing Bi on the current collector.

### [Production of Battery]

A battery of Example 1 was produced by the following procedure.

First, 80 mg of Li₃YBr₂Cl₄ was put into an insulating outer cylinder and pressure-molded at a pressure of 2 MPa. Next, 20 mg of the second electrolyte material, which had been used for the positive electrode material of Example 1, was added thereto, and this was pressure-molded at a pressure of 2 MPa. Furthermore, 8.2 mg of the positive electrode material was added thereto, and this was pressure-molded at a pressure of 2 MPa. Thus, a stack composed of a positive electrode and a solid electrolyte layer was obtained.

Next, on one side of the solid electrolyte layer opposite to the other side in contact with the positive electrode, the negative electrode was stacked so that the Bi-plated surface was in contact with the solid electrolyte layer. This was pressure-molded at a pressure of 720 MPa to produce a stack composed of the positive electrode, the solid electrolyte layer, and a negative electrode.

Next, stainless steel current collectors were placed on the top and the bottom of the stack, and current collector leads were attached to the current collectors.

Finally, an insulating ferrule was used to block the inside of the insulating outer cylinder from the outside air atmosphere and hermetically seal the insulating outer cylinder. Thus, a battery was produced.

Thus, the battery of Example 1 described above was produced.

### Example 2

A battery of Example 2 was produced in the same manner as in Example 1, except that Li₆PS₅Cl was used for the solid electrolyte layer instead of Li₃YBr₂Cl₄.

### [Charge Test]

A charge test was performed on each of the batteries of Examples 1 and 2 described above under the following conditions.

The battery was placed in a thermostatic chamber set at 85° C.

Constant-current charge was performed at a current value of 6.8 μA equivalent to 0.01 C rate (20-hour rate) relative to the theoretical capacity of the battery. The end-of-charge voltage was set to 4.5 V. Next, constant-current discharge was performed. The end-of-discharge voltage was set to 2.5 V.

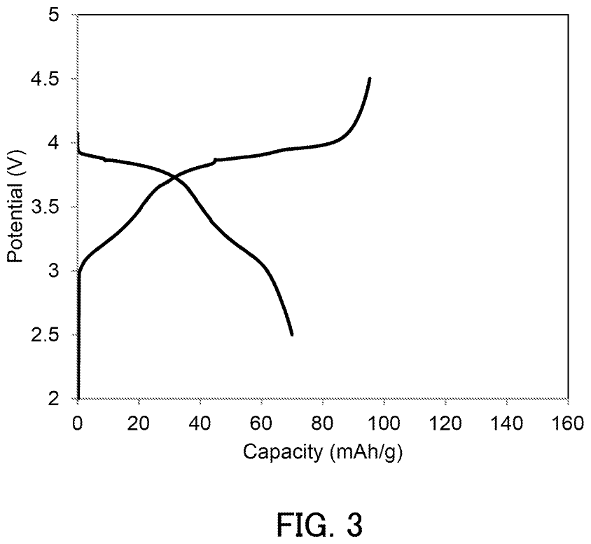

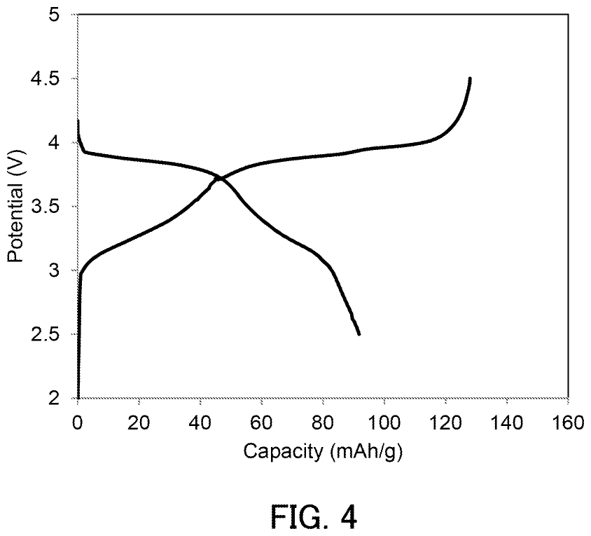

FIG. 3 is a graph showing the charge and discharge curves of the battery of Example 1. FIG. 4 is a graph showing the charge and discharge curves of the battery of Example 2. The battery of Example 1 and the battery of Example 2 were charged and discharged as shown in FIG. 3 and FIG. 4, respectively.

### INDUSTRIAL APPLICABILITY

The battery of the present disclosure can be used as, for example, an all-solid-state lithium-ion secondary battery.

What is claimed is:

1. A battery comprising:
a positive electrode;
a negative electrode; and
an electrolyte layer positioned between the positive electrode and the negative electrode, wherein
the positive electrode includes a positive electrode material,
the positive electrode material includes a positive electrode active material and a first solid electrolyte material,
the positive electrode active material includes an oxide consisting of Li, Ni, Mn, and O,
the first solid electrolyte material includes:
Li;
at least one selected from the group consisting of metalloid elements and metal elements except Li; and
at least one selected from the group consisting of F, Cl, and Br, and
the negative electrode includes Bi as a main component of a negative electrode active material.

2. The battery according to claim 1, wherein
the first solid electrolyte material coats at least a portion of a surface of the positive electrode active material.

3. The battery according to claim 1, wherein
the positive electrode material further includes a second electrolyte material that is a material having composition different from composition of the first solid electrolyte material.

4. The battery according to claim 1, wherein
the positive electrode active material includes a material represented by the following composition formula (1)
LiNiₓMn₂₋ₓO₄ Formula (1), and
the composition formula (1) satisfies 0<x<2.

5. The battery according to claim 4, wherein
the composition formula (1) satisfies 0<x<1.

6. The battery according to claim 5, wherein
the composition formula (1) satisfies x=0.5.

7. The battery according to claim 1, wherein
the oxide has a spinel structure.

8. The battery according to claim 1, wherein
the first solid electrolyte material includes Li, Ti, Al, and F.

9. The battery according to claim 1, wherein
the negative electrode includes a simple substance of Bi as the negative electrode active material.

10. The battery according to claim 1, wherein
the negative electrode is a plating layer.

11. The battery according to claim 3, wherein
the second electrolyte material includes a material represented by the following composition formula (3)
Li_{α3}M_{β3}X_{γ3}O_{δ3} Formula (3)
where α3, β3, and γ3 are each a value greater than 0, and δ3 is a value equal to or greater than 0,
M is at least one selected from the group consisting of metalloid elements and metal elements except Li, and
X is at least one selected from the group consisting of F, Cl, Br, and I.

12. The battery according to claim 11, wherein
the composition formula (3) satisfies:
1≤α3≤4;
0<β3≤2;
3≤γ3<7; and
0≤δ3≤2.

13. The battery according to claim 12, wherein
the composition formula (3) satisfies:
2.5≤α3≤3;
1≤β3≤1.1;
γ3=6; and
δ3=0.

14. The battery according to claim 1, wherein
the electrolyte layer includes a sulfide solid electrolyte.

15. The battery according to claim 14, wherein
the sulfide solid electrolyte is Li₆PS₅Cl.

16. The battery according to claim 1, wherein
the electrolyte layer includes a material including:
Li;
at least one selected from the group consisting of metalloid elements and metal elements except Li; and
at least one selected from the group consisting of F, Cl, and Br.

17. The battery according to claim 16, wherein
the electrolyte layer includes Li₃YBr₂Cl₄.

18. The battery according to claim 1, wherein
the electrolyte layer includes a first electrolyte layer and a second electrolyte layer,
the first electrolyte layer is positioned between the positive electrode and the negative electrode, and
the second electrolyte layer is positioned between the first electrolyte layer and the negative electrode.

19. The battery according to claim 18, wherein
the positive electrode material further includes a second electrolyte material that is a material having composition different from composition of the first solid electrolyte material, and
the first electrolyte layer includes a material having the same composition as composition of the second electrolyte material.
